(19) United States
(12) Patent Application Publication
(10) Pub. No.: US 2004/0054970 A1
(43) Pub. Date: Mar. 18, 2004

(54) System and method for facilitating XML transactions with MFS-based IMS applications

(75) Inventors: Chenhuei J. Chiang, San Jose, CA (US); Shyh-Mei F. Ho, Cupertino, CA (US); Jenny Chengyin Hung, Fremont, CA (US); Benjamin Johnson Sheats, San Jose, CA (US)

Correspondence Address: John L. Rogitz, Rogitz & Associates, Suite 3120, 750 B Street, San Diego, CA, 92101, US

(73) Assignee: International Business Machines Corporation, Armonk, NY

(21) Appl. No.: 10/244,722

(22) Filed: Sep. 16, 2002

(51) Int. Cl. G06F 15/00

(52) U.S. Cl. 715/523

(57) ABSTRACT

A system and method for facilitating transactions between XML and MFS-bases IMS applications utilizes an MFS XML adapter to translate between XML and MFS. A client can input an request formatted using XML to the MFS XML adapter. The MFS XML adapter translates the request and sends the request to an MFS-based IMS application residing in a mainframe. A response is generated by the MFS-based IMS application and sent back to the MFS XML adapter where it is translated back to XML. The response is then returned to the client program.

### I. FIELD OF THE INVENTION

The present invention relates generally to computer software, and more specifically to IMS software.

### II. BACKGROUND OF THE INVENTION

By some estimates, nearly seventy percent (70%) of corporate data in the United States and abroad resides on mainframe computers, e.g., S/390 mainframes manufactured by International Business Machines. Moreover, business-to-business (B2B) e-commerce is expected to grow at least five times faster than the rate of business-to-consumer (B2C) e-commerce. Many transactions involving this corporate data can be initiated by Windows/NT servers, UNIX servers, and other servers but the transactions must be completed on the mainframe using existing legacy applications residing thereon.

One very crucial group of legacy applications are the message format service-based information management system applications (“MFS-based IMS applications”) on which many businesses depend heavily. MFS is a facility of the IMS transaction management environment that formats messages to and from many different types of terminal devices. As businesses upgrade their technologies to exploit new B2B technologies, there is a requirement for an easy and effective method for upgrading existing MFS applications to include e-business capabilities. One such e-business capability is the ability to send and receive MFS-based IMS transaction messages as extensible markup language (XML) documents.

The MFS language utility compiles MFS source, generates MFS control blocks in a proprietary format, known as Message Input/Output Descriptors (MID/MOD), and places them in an IMS format library. MFS supports several terminal types, e.g., IBM 3270 terminals, and it was designed so that the IMS application programs using MFS do not have to deal with any device-specific characteristics in the input or output messages. Because MFS provides headers, page numbers, operator instructions, and other literals to the device, the application's input and output messages can be built without having to pass these format literals. MFS identifies all fields in the message response and formats these fields according to the specific device type. This allows application programmers to concentrate their efforts on the business logic of the programs.

Because the IMS application program input/output data structures do not fully describe the end user interaction with these existing MFS applications, there exists a need for a means to deal with information that is buried within various MFS statements. Examples of this information includes 3270 screen attribute bytes and preset function key (PFKey) input data. Many MFS-based IMS application programs are passed PFKey data in input messages, but application logic is not required to recognize that a certain PFKey was pressed and a literal corresponding to that PFKey must be inserted into the input message. This is due to the fact that, at runtime, it is the MFS online processing and not the application that places the literal that corresponds to the PFKey pressed into the appropriate field in the input message.

XML has become the preferred data format to support Web services, B2C and B2B interchanges. However, presently, there does not exist any way by which hypertext transfer protocol (HTTP) requests can be presented to an MFS-based IMS application and HTTP responses returned.

Accordingly, there is a need for a system and method which will facilitate the accessibility of MFS-based IMS applications with requests that are formatted using XML. In a business-to-consumer environment, the XML transactions are input via an Internet browser. On the other hand, in a business-to-business environment there is no need for a browser.

### SUMMARY OF THE INVENTION

An MFS XML adapter includes logic means for receiving at least one client request in a predetermined format from a client program via a network connection and logic means for translating the request to MFS. The adapter also includes logic means for sending a translated request to an MFS-based IMS application.

In a preferred embodiment, the adapter further includes logic means for receiving a response to the translated request and logic means for translating the response to the predetermined format. Preferably, the adapter includes logic means for returning the translated response to the client program. The adapter can reside in a server that is distanced from the client program while the MFS-based IMS application can reside in a mainframe that is distanced from the server and the client program. On the other hand, the adapter can reside in a mainframe that is distanced from the client program and the MFS-based IMS application can reside in the same mainframe as the adapter. Preferably, the MFS XML adapter can be established by an MFS servlet, user written code, or a SOAP MFS handler. In a preferred embodiment, the client request is an extensible mark-up language document.

In another aspect of the preferred embodiment of the present invention, a method for accessing MFS-based IMS applications includes sending a client request to an MFS-based IMS application from a client program via an MFS XML adapter. The adapter translates the client request from a predetermined format to MFS. Also, a response is received from the MFS-based IMS application at the client program via the MFS XML adapter.

In yet another aspect of the preferred embodiment of the present invention, a method for accessing MFS-based IMS applications includes receiving a client request from a client program in a predetermined format at an MFS XML adapter. The client request is translated to MFS and the translated client request is sent to an MFS-based IMS application.

In still another aspect of the preferred embodiment of the present invention, a method for accessing MFS-based IMS applications includes receiving a client request from a client program via an MFS XML adapter and returning a response to the client program via the MFS XML adapter.

The preferred embodiment of the present invention will now be described, by way of example, with reference to the accompanying drawings, in which:

### BRIEF DESCRIPTION OF THE DRAWINGS

FIG. 1 is a flow chart of the overall logic of the present invention;

FIG. 2 is a flow chart of the general translation logic of the present invention;

FIG. 3 is a flow chart of the XML/MFS translation logic of the present invention;

FIG. 4 is a block diagram of first system architecture;

FIG. 5 is a block diagram of a second system architecture;

FIG. 6 is a block diagram of a third system architecture;

FIG. 7 is a block diagram of a fourth system architecture; and

FIG. 8 is a block diagram of a fifth system architecture.

### DESCRIPTION OF AN EMBODIMENT OF THE INVENTION

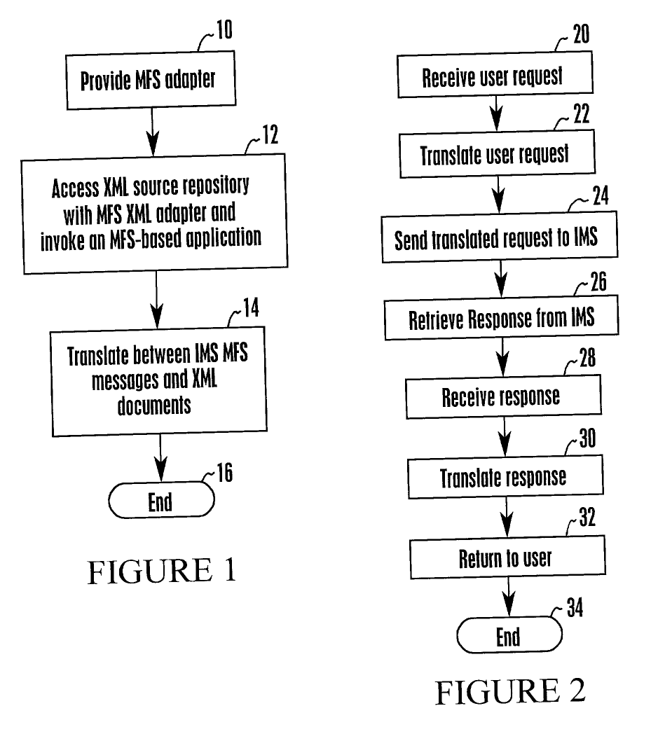

Referring initially to FIG. 1, the overall operating logic of the present invention is shown and commences at block 10 wherein an MFS XML adapter is provided. As described below, the MFS XML adapter includes a mapper which maps the XML document pertaining to the device information into the appropriate MFS XML messages (and vice versa). Also, the MFS XML adapter includes a converter that transforms the MFS XML messages into a byte stream and vice versa. The MFS mapper reads and parses MFS source files for a particular application and generates XMI files that describe the MFS-based application interface using the MFS Metamodel discussed in U.S. patent application Ser. No. 09/849,105, filed on May 4, 2001, incorporated herein by reference, which is part of the Common Application Metamodel (CAM) disclosed in U.S. Patent Application, serial No. 60/223,671 filed Aug. 8, 2000, also incorporated herein by reference.

It is to be understood that there are three external reference pointers to a particular MFS source file: message input descriptor (MID), message output director (MOD), and table. The MFS mapper generates three XMI files for the three external reference pointers. These three files include a “midname.xmi” file for each MID with its associated device input format (DIF), a “modname.xmi” file for each MOD with its associated device output format (DOF), and a “tablename.xmi” file. These XMI files represent all the application interface information encapsulated by the MFS source including the input and output messages, display information, MFS flow control, device characteristics and operation semantics. With these XMI files and the MFS converter, MFS-based IMS applications can support B2B XML communication without altering the MFS-based IMS application.

Returning to FIG. 1, at block 12, the MFS XML adapter has access to an XML source repository and can properly invoke an MFS-based IMS application. It can be appreciated that the MFS-based IMS application contains corporate data, e.g., airline reservation data, rental car availability data, credit data, inventory data, news data, weather data, scheduling data, etc. Continuing to block 14, the MFS XML adapter is used to translate between IMS MFS messages and XML documents. The logic then ends at state 16. As described in greater detail below, the above logic allows a client program to access an MFS-based IMS application via the Internet.

FIG. 2 shows the general translation logic utilized by the MFS XML adapter. Beginning at block 20, a client request (or, a user request), e.g., an HTTP XML document or a SOAP XML document, is received at the MFS XML adapter. At block 22, the MFS XML adapter translates the client request to an IMS MFS message, the XML/MFS translation logic is described in greater detail below. Moving to block 24, the translated request is sent to the MFS-based IMS application. Next, at block 26, a response to the translated request is retrieved from the MFS-based IMS application. Continuing to block 28, the response is received at the MFS XML adapter. The response is translated, at block 30, from an IMS MFS message to the format of the client request, e.g., HTTP XML, SOAP XML, etc. Proceeding to block 32, the translated response is returned to the client program. The logic then ends at state 34.

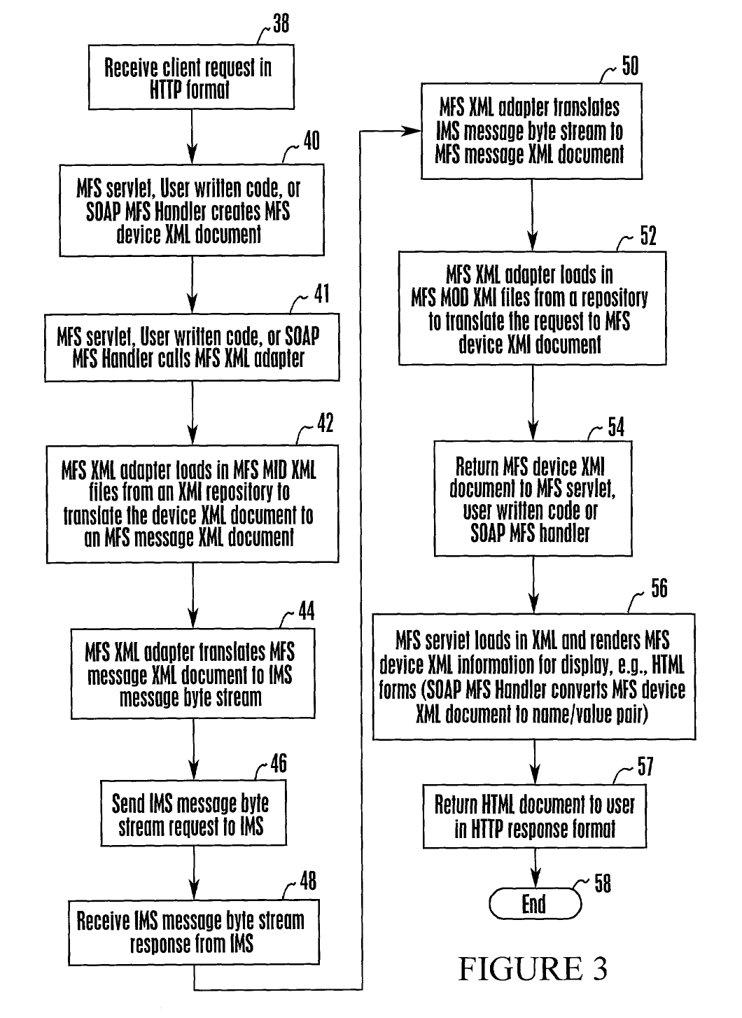

Referring now to FIG. 3, the XML/MFS translation logic is shown and commences at block 38, wherein a client request is received at an MFS servlet in HTTP request format. Next, at block 40, the MFS servlet creates, user written code, or a SOAP MFS Handler creates an MFS device XML document. At block 41, the MFS servlet, user written code, or SOAP MFS Handler calls the MFS XML adapter and sends the MFS device XML document to the MFS XML adapter. Proceeding to block 42, the MFS XML adapter loads in MFS MID XML files from an XMI repository to translate the device XML document to an MFS message XML document. Moving to block 44, the MFS XML adapter translates the MFS message XML document to an IMS message byte stream. Next, at block 46, the IMS message byte stream request is sent to the MFS-based IMS application. Continuing to block 48, an IMS message byte stream response is received by an MFS XML adapter. At block 50, the MFS adapter translates the IMS message byte stream to an MFS message XML document. Then, at block 52, the MFS XML adapter loads in MFS MOD XMI files from an XMI repository to translate the request to an MFS device XMI. Moving to block 54, the populated MFS XMI document is returned to the MFS servlet, user written code, or SOAP MFS Handler. At block 56, the MFS servlet loads in XML and renders MFS device XML information for display, e.g., HTML forms. In a situation that uses a SOAP MFS handler, the SOAP MFS Handler converts the MFS device XML document to a name/value pair. Then, at block 57, the generated HTML document is returned in HTTP response format or the name/value pair, encapsulated as payload in a SOAP message is returned to the client, e.g., to the client's web browser. The logic then ends at state 58.

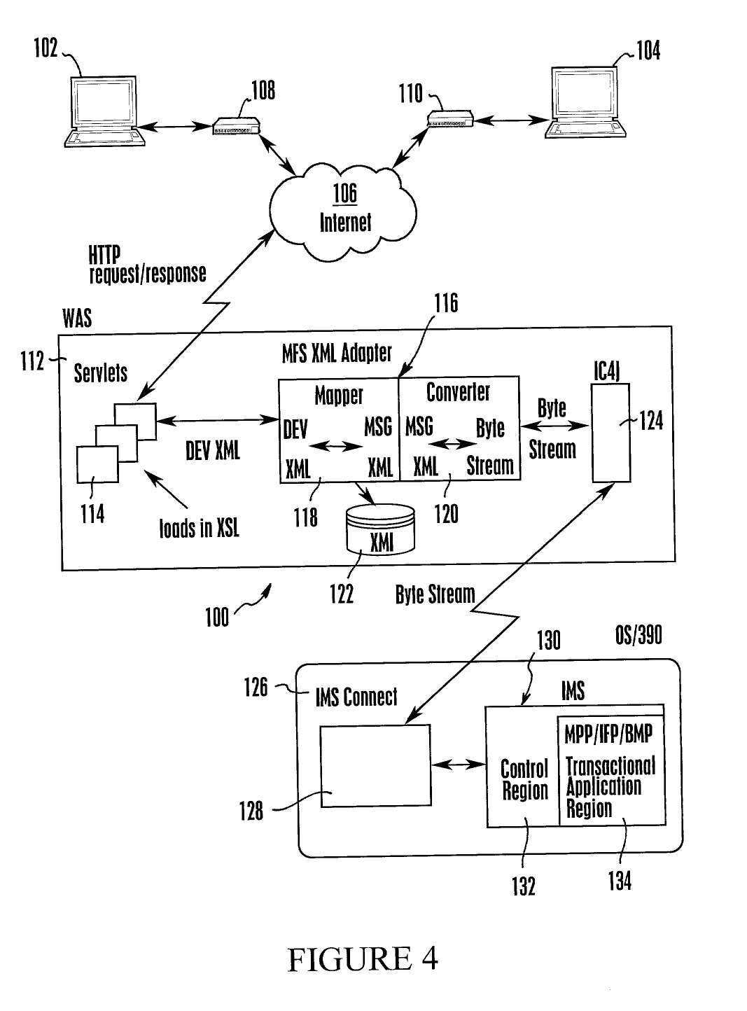

FIGS. 4 through 8 show various systems in which the MFS XML adapter utilizing the above logic can be incorporated. FIG. 4 shows a WebSphere application server (WAS) system that is generally designated 100. Typically, this system 100 is used in for B2C transactions and not B2B transactions. It is to be understood that this system can be any other equivalent web application server system, e.g., TomCat, etc. As shown, the WAS system 100 includes a first client computer 102 and a second client computer 104 that are connected to the Internet 106 by respective modems 108, 110. FIG. 4 shows that the Internet 106 provides a connection to a WebSphere application server (WAS) 112. It is to be understood that client programs that reside in the client computers 102, 104 can communicate with an MFS-based IMS application, described below, via the Internet 106 and the WAS 112.

Within the WAS 112, are plural servlets 114 that load in extensible stylesheet language (XSL) for rendering output displays. The result of the rendering, e.g., an HTML document, is sent back to the client computer 102, 104 in an HTTP response. Each servlet 114 communicates with the MFS XML adapter 116 in which the logic depicted in FIGS. 2 and 3 resides. The servlets 114 send and receive XML documents to and from the MFS XML adapter 116. As shown in FIG. 4, the MFS XML adapter 116 includes an MFS mapper 118 and an MFS converter 120. The MFS mapper 118 is connected to an MFS XMI database 122. The MFS mapper 118 and the MFS converter 120 work together to translate the XML documents into a byte stream that is sent to an IMS connector for Java (IC4J) 124. The IC4J 124 sends the byte stream to a mainframe 126, e.g., an IBM S/390. At the mainframe, the byte stream is received by IMS connect (IC) 128 which, in turn, sends the byte stream to an IMS transaction system 130 within the IMS space of the mainframe 126 via TCP/IP. FIG. 4 shows that in a preferred embodiment the IMS transaction system 130 can include a control region 132 and a transactional application region 134 where IMS applications reside. It is to be understood that, in the above described WAS system 100, the translation between XML and byte stream occurs within MFS XML adapter 116 which resides inside the WAS 112, or any other web application server.

It is to be understood that each servlet 114 works in conjunction with the MFS XML adapter 116 to transform the HTTP request into a byte stream as input to the IC4J 124 and produce an HTTP response on return. The servlets 114 are responsible for handling display information and producing simulated DIF XMI, and vice versa. The MFS XML adapter 116 is responsible for transforming the XMI into a byte stream and communicating with the IC4J 124—handling both device and message information. Preferably, the MFS XML adapter 116 uses interpretive marshaling based on dynamical lookup of XMI files to ensure system stability.

Further, it is to be understood that all the servlets 114 are subclassed, or inherited, from a generic MFS servlet that contains the bulk of the logic code of the present invention. The generic servlet is responsible for processing the HTTP XML request, invoking the adapter, and loading the stylesheet. Preferably, the generic MFS servlet has the ability to cache the entire message and only return a single page at time to the client computer. Thus, the client is able to page through logical pages and physical pages without making extra requests to the MFS XML adapter 116 (and the IMS transaction system 130). In a preferred embodiment, the generic servlet passes to a predetermined stylesheet only the device page and device fields pertaining to the current physical and logical page. Preferably, an instance servlet is only generated for each initial MOD. Once an HTTP session is established with a particular client, the session can keep track of which page the client is currently viewing. The instance servlet can provide key details regarding the specific transaction. These details can include IMS information (e.g., hostname, port number, and data store name), stylesheet name, and initial MFS modname.

While the servlets 114 handle only the device side of the MFS model, the MFS XML adapter 116 preferably handles both the device side and the message side of the model. As stated above, the MFS XML adapter 116 includes two parts: the MFS mapper 118 and the MFS converter 120. Based on the information contained in the MID/MOD XMI file, the MFS mapper 118 will map the simulated input device information into the appropriate message components (and vice versa). In a preferred, non-limiting embodiment, the simulated input device information is as follows:

<?xml version=”1.0″ encoding=”UTF-8″?>
<xmi:XMI xmi:version=”2.0″ xmlns:xmi”http://www.omg.org/XMI”xmlns:mfs
=”mfs.xmi”>

<mfs:MFSFormat xmi:id=”MFSFormat_1″>

<devices xmi:id=”MFSDevice_1″>

<devicePages xmi:id=”MFSDevicePage_1″>

<deviceFields xmi:id=”MFSDeviceField_1″ label=”LABEL1″ value

=”VALUE1″>

<deviceFields xmi:id=”MFSDeviceField_2″ label=”LABEL2″ value

=”VALUE2″>

<deviceFields xmi:id=”MFSDeviceField_N″ label=”LABELN″ value

=”VALUEN″>

</devicePages>
<division xmi:id=”MFSDeviceDivision/” type=”in”>

</devices>

</mfs:MFSFormat></xmi:XMI>

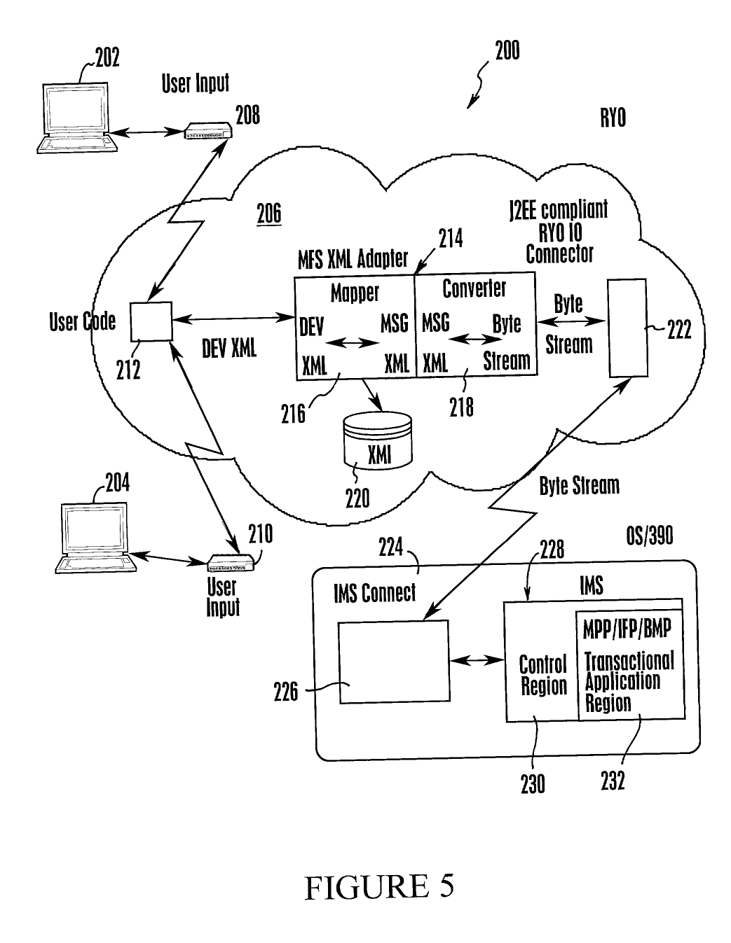

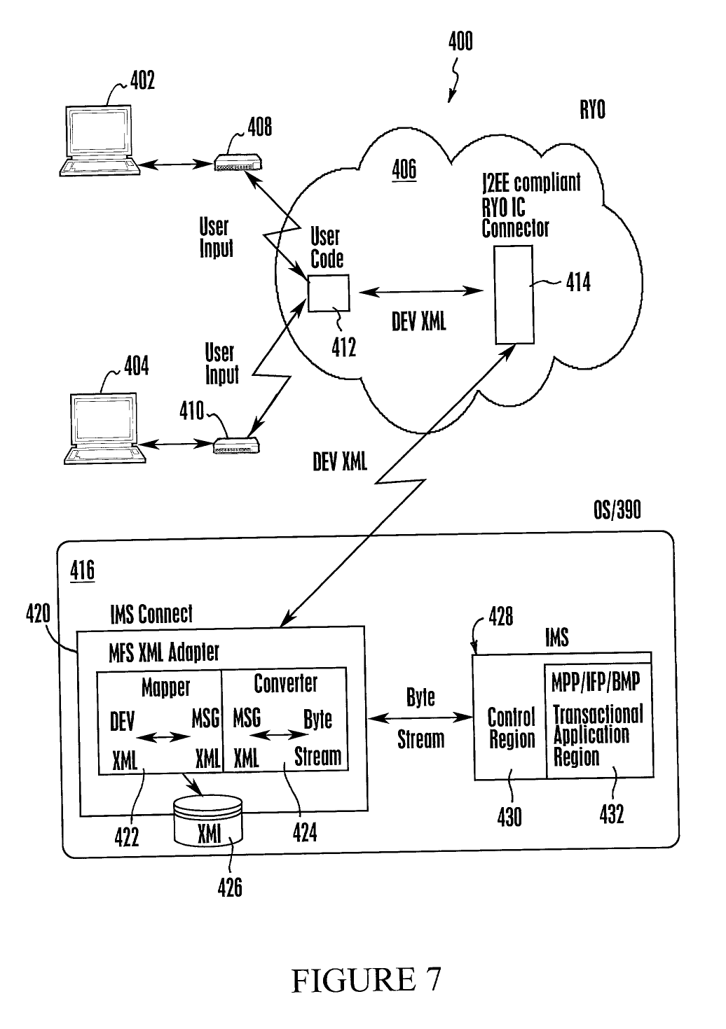

In a preferred embodiment, only the MFS mapper 118 accesses the MFS XMI database 122. Additionally, the MFS mapper 118 preferably handles communication with the IC4J 124. It is to be understood that the MFS XML adapter 116 and the IC4J 124 operate under the J2EE framework. Thus, an IC Client connector substituted for the IC4J 124 has to be J2EE compliant as well, as shown in FIGS. 5 and 7 and described below. Preferably, the MFS mapper 118 handles the situation when the IMS transaction system 130 switches the modname during data transfer by transparently loading the new MFS XMI file and returning the new device XMI to the servlet for display. In a preferred embodiment, if the corresponding MFS XMI file cannot be located for the specific modname, the MFS mapper 118 quits processing and returns a failure message.

It is to be understood that the MFS converter 120 of the MFS XML adapter 116 transforms the XMI message into a byte stream and transforms a byte stream into an XMI message. The MFS converter 120 only deals with the message side of the MFS model. The MFS converter 120, when converting to and from a byte steam, uses predetermined Type Descriptor classes in the XMI file to perform the low level UNICODE to extended binary coded decimal information code (EBCDIC) conversion.

Referring now to FIG. 5, a roll-your-own (RYO), or client customized, IC system is shown and generally designated 200. It is to be understood that this system 200 is typically used for B2B transactions and not B2C transactions. FIG. 5 shows that the RYO IC system 200 includes a first client computer 202 and a second client computer 204 connected to a RYO IC client application program 206 via respective networking devices 208, 210. It is to be understood that at least one client program resides on the client computers 202, 204. Specifically, the computers 202, 204 are connected to user written code 212. The user written code 212 is connected to the MFS XML adapter 214 that includes an MFS mapper 216 and an MFS converter 218. The MFS mapper 216 is connected to an MFS-based extensible markup language meta data interchange (XMI) database 220. The MFS mapper 216 and the MFS converter 218 work together to translate XML documents into a byte stream that is sent to a J2EE compliant RYO IC Connector 222. The J2EE compliant RYO IC Connector 222 sends the byte stream to a mainframe 224, e.g., an IBM S/390. At the mainframe 224, the byte stream is received by IMS connect (IC) 226 which, in turn, sends the byte stream to the IMS transaction system 228 within the mainframe 230. FIG. 5 shows that the IMS transaction system 228 includes a control region 230 and a transactional application region 232. It is to be understood that, in the above described RYO IC system 200, the translation between XML and byte stream occurs within any RYO IC client application program 206 in the network.

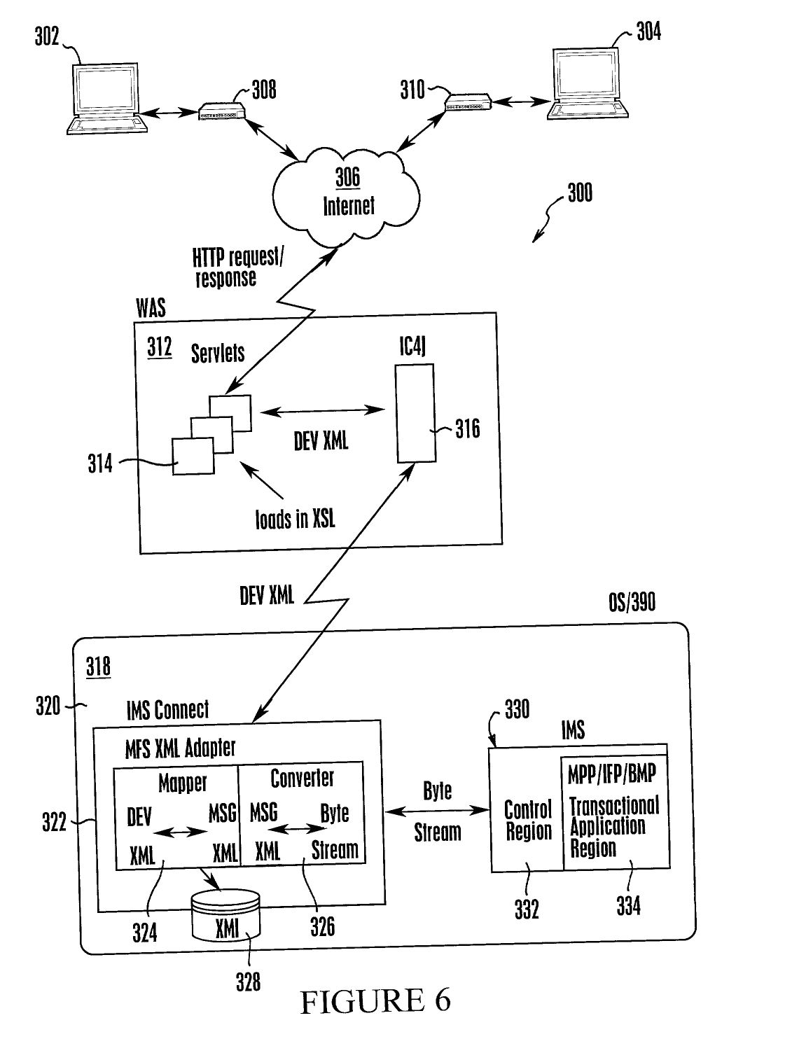

FIG. 6 shows an alternative WebSphere application server (WAS) system that is generally designated 300. As shown, the WAS system 300 includes a first client computer 302 and a second client computer 304 connected to the Internet 306 by respective modems 308, 310. It is to be understood that at least one client program resides on the client computers 302, 304. FIG. 6 shows that the Internet 306 provides a connection to a WebSphere application server (WAS) 312.

Within the WAS 312, are plural servlets 314 that load in extensible stylesheet language (XSL) for rendering output displays. The result of the rendering, e.g., an HTML document, is sent back to the client computer 102, 104 in an HTTP response. The servlets 314 are connected to an IC4J 316 that sends the XML request to the mainframe 318, e.g., the S/390 mainframe. Within the mainframe 318 is IMS connect 320 that includes an MFS XML adapter 322 in which the translation logic depicted in FIGS. 2 and 3 resides. As shown in FIG. 6, the MFS XML adapter 322 includes an MFS mapper 324 and an MFS converter 326. As shown, the MFS mapper 324 is connected to an MFS XMI database 328. The MFS mapper 324 and the MFS converter 326 work together to translate the XML documents into a byte stream that is sent to an IMS transaction system 330 within the mainframe 318. FIG. 6 shows that the IMS transaction system 330 includes a control region 332 and a transactional application region 334. It is to be understood that, in the above described WAS system 300, the translation between XML and byte stream occurs within the IMS connect 320 of the mainframe 318.

Referring now to FIG. 7, an alternative roll-your-own (RYO) IC system is shown and generally designated 400. It is to be understood that this system is typically used for B2B transactions and not B2C transactions. FIG. 7 shows that the RYO IC system 400 includes a first client computer 402 and a second client computer 404 connected to a RYO IC client application program 406 via respective networking devices 408, 410. Specifically, the computers 402, 404 are connected to a user written code 412. It is to be understood that at least one client program resides on the client computers 402, 404.

As shown in FIG. 7, the user written code 412 is connected to a J2EE compliant RYO IC connector 414, that sends the XML request to a mainframe 416, e.g., the S/390 mainframe. Within the mainframe 416 is IMS connect 418 that includes an MFS XML adapter 420 that utilizes the translation logic depicted in FIGS. 2 and 3. As shown in FIG. 7, the MFS XML adapter 420 includes an MFS mapper 422 and an MFS converter 424. As shown, the MFS mapper 422 is connected to an MFS XMI database 426. The MFS mapper 420 and the MFS converter 424 work together to translate the XML documents into a byte stream that is sent to an IMS transaction system 428 also within the mainframe 416. FIG. 7 shows that the IMS transaction system 428 includes a control region 430 and a transactional application region 432. It is to be understood that, in the above described RYO IC system 400, the translation between XML and byte stream occurs within IMS Connect 418 of the mainframe 416.

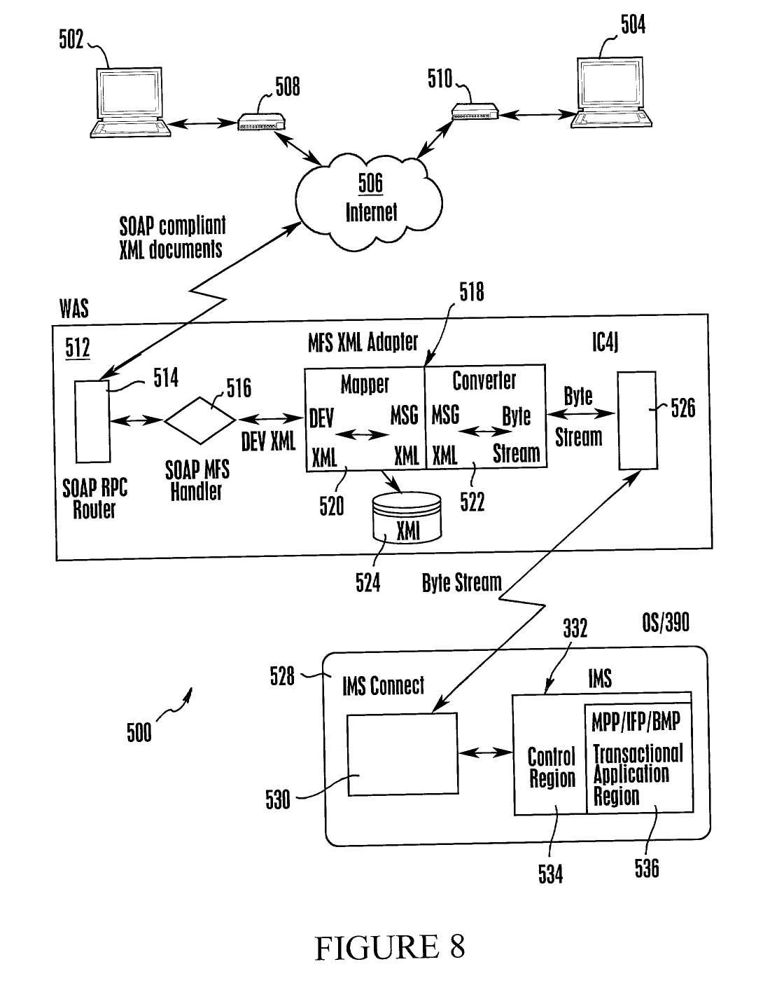

FIG. 8 shows a third WAS system, generally designated 500, in which SOAP compliant XML documents are utilized. As shown, the system 500 includes a first client computer 502 and a second client computer 504 that are connected to the Internet 506 by respective modems 508, 510. FIG. 8 shows that the Internet 506 provides a connection to a WAS 512. It is to be understood that at least one client program resides on the client computers 502, 504.

Within the WAS 512, is a SOAP RPC Router 514 that receives SOAP compliant XML documents. The router 514 constructs a name/value pair from the SOAP compliant XML documents and sends them to a SOAP MFS handler 516. The SOAP MFS handler 516 sends a DEV XML document to an MFS XML adapter 518 in which the logic depicted in FIGS. 2 and 3 resides. As shown in FIG. 8, the MFS XML adapter 518 includes an MFS mapper 520 and an MFS converter 522. The MFS mapper 520 is connected to an MFS XMI database 524. In accordance with the translation logic, the MFS mapper 520 and the MFS converter 522 work together to translate the DEV XML documents into a byte stream that is sent to an IC4J 526. The IC4J 526 sends the byte stream to a mainframe 528, e.g., an IBM S/390. At the mainframe, the byte stream is received by an IMS connect (IC) 530 which, in turn, sends the byte stream to an IMS transaction system 532 within the mainframe 528. FIG. 8 shows that the IMS transaction system 532 includes a control region 534 and a transactional application region 536. It is to be understood that, in the above described WAS system 500, the translation between XML and byte stream occurs within the MFS XML adapter 518 that resides in the WAS 512.

It can be appreciated that in each of the exemplary systems 100, 200, 300, 400, 500, described above, the client requests, e.g., HTTP XML documents or a SOAP XML documents, are received at a generic MFS XML adapter 116, 214, 322, 420, 518. The MFS XML adapter 116, 214, 322, 420, 518 converts the client requests into MFS-based IMS message byte streams and sends them to MFS-based IMS applications 130, 228, 330, 428, 532 where they can be processed. The MFS-based IMS applications return responses that are converted by the MFS XML adapter 116, 214, 322, 420, 518 back into HTTP XML documents or SOAP XML documents that can be rendered at one or more clients' web browsers. Thus, the MFS XML adapter 116, 214, 322, 420, 518 acts as a two-way translator to facilitate client interaction with MFS-based IMS applications 130, 228, 330, 428, 532 via the Internet 106, 306, 506 or an RYO connection 206, 406.

It is to be understood that in each of the systems above, the translation logic can be contained on a data storage device with a computer readable medium, such as a computer diskette. Or, the instructions may be stored on a magnetic tape, hard disk drive, electronic read-only memory (ROM), optical storage device, or other appropriate data storage device or transmitting device thereby making a computer program product, i.e., an article of manufacture according to the invention. In an illustrative embodiment of the invention, the computer-executable instructions may be lines of C++ compatible code.

The flow charts herein illustrate the structure of the logic of the present invention as embodied in computer program software. Those skilled in the art will appreciate that the flow charts illustrate the structures of computer program code elements including logic circuits on an integrated circuit, that function according to this invention. Manifestly, the invention is practiced in its essential embodiment by a machine component that renders the program elements in a form that instructs a digital processing apparatus (that is, a computer) to perform a sequence of function steps corresponding to those shown.

With the configuration of structure described above, it is to be appreciated that system and method described above provides a means for receiving web-based client requests, translating them to MFS IMS, and submitting the translated requests to MFS-based IMS applications. Thus, corporate data and other data that operates within MFS-based IMS application programs and that is typically accessed via terminals can be accessed via Internet connections. This allows corporations the option of allowing access to their data via the Internet.

While the particular SYSTEM AND METHOD FOR FACILITATING XML TRANSACTIONS WITH MFS-BASED IMS APPLICATIONS as herein shown and described in detail is fully capable of attaining the above-described aspects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

1. An MFS XML adapter, comprising:
logic means for receiving at least one client request in a predetermined format from a client program via a network connection;
logic means for translating the request to MFS XML; and
logic means for sending a translated request to an MFS-based IMS application.

2. The adapter of claim 1, further comprising:
logic means for receiving a response to the translated request.

3. The adapter of claim 2, further comprising:
logic means for translating the response to the predetermined format.

4. The adapter of claim 3, further comprising:
logic means for returning the translated response to the client program.

5. The adapter of claim 1, wherein the adapter resides in a server that is distanced from the client program.

6. The adapter of claim 5, wherein the MFS-based IMS application resides in a mainframe that is distanced from the server and the client program.

7. The adapter of claim 1, wherein the adapter resides a mainframe that is distanced from the client program.

8. The adapter of claim 7, where in the MFS-based IMS application resides in the same mainframe as the adapter.

9. The adapter of claim 1, wherein the client request is an extensible mark-up language document.

10. The adapter of claim 1, wherein the MFS XML adapter is established by an MFS servlet.

11. The adapter of claim 1, wherein the MFS XML adapter is established by user written code.

12. The adapter of claim 1, wherein the MFS XML adapter is established by a SOAP MFS handler.

13. A method for accessing MFS-based IMS applications, comprising the acts of:
sending a client request to an MFS-based IMS application from a client program via an MFS XML adapter, the adapter translating the client request from a predetermined format to MFS XML; and
receiving a response from the MFS-based IMS application at the client program via the MFS XML adapter.

14. The method of claim 13, wherein the MFS XML adapter translates the response from MFS to the predetermined format.

15. The method of claim 13, wherein the MFS XML adapter resides in a server that is distanced from the client program.

16. The method of claim 13, wherein the MFS-based IMS application resides in a mainframe that is distanced from the server.

17. The method of claim 13, wherein the adapter resides a mainframe that is distanced from the client program.

18. The method of claim 17, where in the MFS-based IMS application resides in the same mainframe as the adapter.

19. The method of claim 13, wherein the client request is an extensible mark-up language document.

20. A method for accessing MFS-based IMS applications, comprising the acts of:
receiving a client request from a client program in a predetermined format at an MFS XML adapter;
translating the client request to MFS; and
sending a translated client request to an MFS-based IMS application.

21. The method of claim 20, further comprising the act of:
receiving a response from the MFS-based IMS application.

22. The method of claim 21, further comprising the act of:
translating the response from the MFS-based IMS application to the predetermined format.

23. The method of claim 22, further comprising the act of:
returning the translated response to the client program.

24. The method of claim 20, wherein the MFS XML adapter resides in a server that is distanced from the client program.

25. The method of claim 24, wherein the MFS-based IMS application resides in a mainframe that is distanced from the server.

26. The method of claim 20, wherein the adapter resides a mainframe that is distanced from the client program.

27. The method of claim 26, where in the MFS-based IMS application resides in the same mainframe as the adapter.

28. The method of claim 20, wherein the client request is an extensible mark-up language document.

29. A method for accessing MFS-based IMS applications, comprising the acts of:
receiving a client request from a client program via an MFS XML adapter; and
returning a response to the client program via the MFS XML adapter.

30. The method of claim 29, wherein the MFS XML adapter translates the client request from a predetermined format to MFS.

31. The method of claim 30, wherein the MFS XML adapter translates the response from MFS to the predetermined format.

32. The method of claim 29, wherein the MFS XML adapter resides in a server that is distanced from the client program.

33. The method of claim 32, wherein the MFS-based IMS application resides in a mainframe that is distanced from the server.

34. The method of claim 29, wherein the adapter resides a mainframe that is distanced from the client program.

35. The method of claim 34, where in the MFS-based IMS application resides in the same mainframe as the adapter.

36. The method of claim 29, wherein the client request is an extensible mark-up language document.
